(19) United States
(12) Patent Application Publication
(10) Pub. No.: US 2007/0165999 A1
(43) Pub. Date: Jul. 19, 2007

(54) Coded-data decoding/playback apparatus

(76) Inventors: Hirofumi Nishikawa, Tokyo (JP); Shunichi Sekiguchi, Tokyo (JP); Yoshiaki Kato, Tokyo (JP)

Correspondence Address: BIRCH STEWART KOLASCH & BIRCH, PO BOX 747, FALLS CHURCH, VA, 22040-0747, US

(21) Appl. No.: 10/590,148

(22) PCT Filed: Apr. 13, 2004
(86) PCT No.: PCT/JP04/05265

§ 371 Date: Aug. 21, 2006

(51) Int. Cl. H04N 5/91

(52) U.S. Cl. 386/68

(57) ABSTRACT

A coded-data decoding/playback apparatus includes an image decoding means 2 for decoding blocks containing intra-coded data which can be independently decoded and which is include in inputted compressed image data in response to the placement of the image decoding means in a trick play mode in which image data is played back at a high speed, an image storage means 3 for storing decoded image data about the decoded blocks, and an image decoding/playback control means 4 for placing the image decoding means 2 and image storage means 3 in the trick play mode so as to superimpose the decoded image data about the blocks on one another, to make the image storage means 3 store the superimposed decoded image data, and to make the image storage means 3 output the decoded image data about the blocks at a playback speed which is specified thereby.

### FIELD OF THE INVENTION

The present invention relates to a coded-data decoding/playback apparatus which decodes compressed image data and performs trick mode playback, such as fast forward playback, of the decoded image data.

### BACKGROUND OF THE INVENTION

As a related art coded-data decoding/playback apparatus which decodes compressed image data which are compression-coded using a compression method, such as an MPEG (Moving Picture Experts Group)-based compression method, and which implements a trick mode playback function which is similar to fast forward playback of an analog VTR, there has been provided, for example, an image data recording/playback apparatus disclosed by the Japanese patent No. 3034172 (JP,8-125967,A). In general, a slice which can be decoded independently among general compressed image data which are compression-coded includes a non-intra macroblock which needs prediction besides an intra macroblock which does not need prediction. This conventional example aims at fast forward playback of compressed image data recorded on a digital VTR, and converts compression-coded compressed moving image data into compressed image data including blocks each of which is called an intra slice and includes only one or more intra macroblocks which can be decoded independently. When carrying out trick mode playback of the compressed image data, the related art image data recording/playback apparatus extracts only the above-mentioned intra slices from the compressed image data into which the compression-coded compressed moving image data have been converted, decodes the intra slices, and displays the decoded intra slices.

A problem with the related art coded-data decoding/playback apparatus constructed as above is that in order to carry out trick mode playback of compression-coded compressed image data, it must convert the original compression-coded compressed image data into intra slices each including one or more intra macroblocks in advance, and hence needs to hold the converted compressed image data in addition to the original compressed image data as the case may be. Another problem is that since the above-mentioned conversion processing which needs to be performed in advance includes the completely same processes as those performed in the processing for decoding and displaying the compression-coded compressed image data, the structure of the coded-data decoding/playback apparatus becomes complicated.

The present invention is made in order to solve the above-mentioned problems, and it is therefore an object of the present invention to provide a coded-data decoding/playback apparatus which does not need to have converted compressed image data in addition to original compressed image data, and which can implement a trick mode playback function with a simple structure.

### DISCLOSURE OF THE INVENTION

In accordance with the present invention, there is provided a coded-data decoding/playback apparatus including: an image input means for inputting compressed image data; an image decoding means for decoding blocks containing intra-coded data which can be independently decoded and which is included in the compressed image data inputted by the above-mentioned image input means in response to placement of the image decoding means in a trick play mode in which image data is played back at a high speed; an image storage means for storing decoded image data about the above-mentioned blocks decoded by the above-mentioned image decoding means; and an image decoding/playback control means for placing the above-mentioned image decoding means and the above-mentioned image storage means in the trick play mode so as to superimpose the decoded image data about the above-mentioned blocks on one another, to make the above-mentioned image storage means store the superimposed decoded image data, and to make the above-mentioned image storage means output the decoded image data about the above-mentioned blocks stored in the above-mentioned image storage means at a playback speed which is specified thereby.

Therefore, the present invention offers an advantage of being able to avoid the necessity for additionally holding compressed image data into which the inputted original compressed image data are converted and to implement a trick mode playback function with a simple structure by performing trick mode playback processing simultaneously during the process of decoding the inputted compressed image data.

### BRIEF DESCRIPTION OF THE FIGURES

FIG. 1 is a block diagram showing the structure of a coded-data decoding/playback apparatus in accordance with embodiment 1 of the present invention;

FIG. 2 is a diagram for explaining control of a switcher and an image buffer of the coded-data decoding/playback apparatus in accordance with embodiment 1 of the present invention;

FIG. 3 is a diagram for explaining an operation in a trick play mode of the coded-data decoding/playback apparatus in accordance with embodiment 1 of the present invention when compressed image data including two or more coding modes are inputted;

FIG. 4 is a diagram for explaining an operation in a trick play mode of a coded-data decoding/playback apparatus in accordance with embodiment 2 of the present invention when compressed image data including two or more coding modes are inputted;

FIG. 5 is a block diagram showing the structure of a coded-data decoding/playback apparatus in accordance with embodiment 3 of the present invention; and

FIG. 6 is a block diagram showing the structure of a coded-data decoding/playback apparatus in accordance with embodiment 4 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

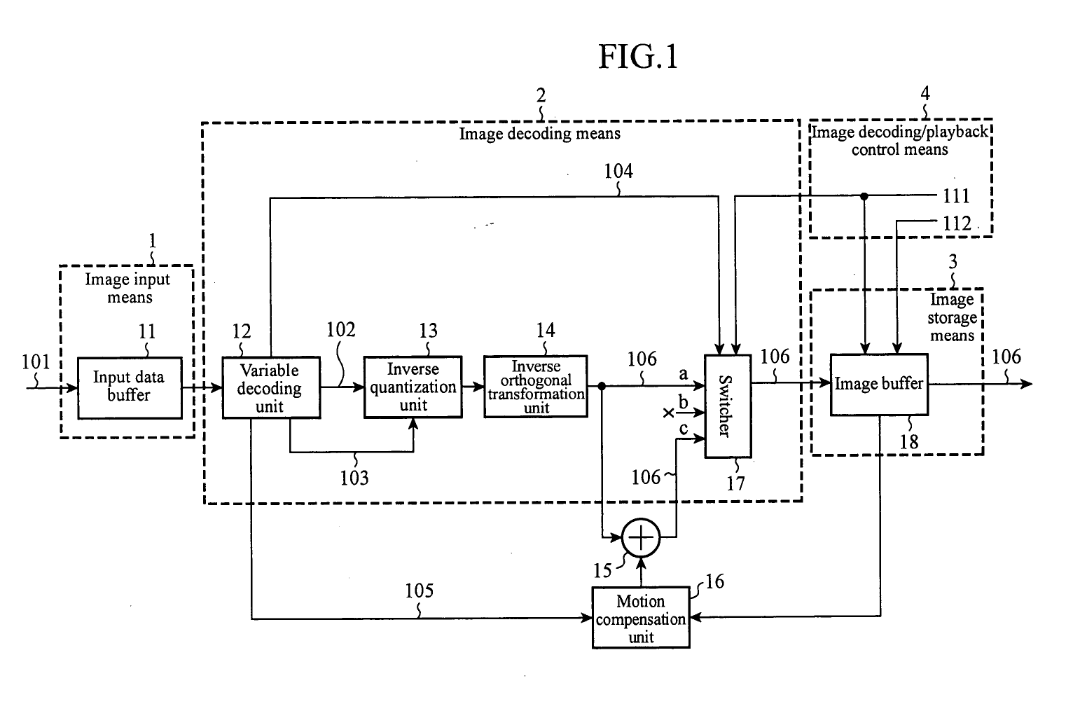

FIG. 1 is a block diagram showing the structure of a coded-data decoding/playback apparatus in accordance with embodiment 1 of the present invention. This coded-data decoding/playback apparatus is provided with an input data buffer 11, a variable length decoding unit 12, an inverse quantization unit 13, an inverse orthogonal transformation unit 14, an adder 15, a motion compensation unit 16, a switcher 17, and an image buffer 18. Playback mode placement information 111 for placing target units in either an ordinary playback mode which complies with a compression method such as an MPEG-based compression method, or a trick play mode, such as a fast forward playback mode, is inputted to the switcher 17 and image buffer 18, and playback-speed specification information 112 for specifying a speed at which an input image is to be played back is inputted to the image buffer 18.

The coded-data decoding/playback apparatus shown in FIG. 1 implements both a function of playing back the input image in the ordinary playback mode which complies with the compression method, such as an MPEG-based compression method, and a function of playing back the input image in the trick play mode, such as a fast forward playback mode. The remainder of the structure shown in FIG. 1 of the coded-data decoding/playback apparatus in which the playback mode placement information 111, playback speed specification information 112, and an input terminal b of the switcher 17 are removed implements the function of playing back the input image in the ordinary playback mode. That is, this coded-data decoding/playback apparatus implements playback of the input image in the trick play mode by adding the very simple structure which consists of the playback mode placement information 111, playback speed specification information 112, and input terminal b of the switcher 17 to the structure intended for playback in the ordinary playback mode.

In FIG. 1, the input data buffer 11 constitutes an image input means 1 for inputting the compressed image data 101. The variable length decoding unit 12, inverse quantization unit 13, inverse orthogonal transformation unit 14, and switcher 17 constitute an image decoding means 2 for decoding each block containing intra-coded data which can be decoded independently in response to the placement of the image decoding means in the trick play mode, each block in question being included in the compressed image data 101 inputted by the image input means 1. The image buffer 18 constitutes an image storage means 3 for storing decoded image data 106 about each block decoded by the image decoding means 2. The playback mode placement information 111 furnished to both the switcher 17 and image buffer 18 and the playback speed specification 112 furnished to the image buffer 18 constitute an image decoding/playback control means 4 for placing the image decoding means 2 and image storage means 13 in the trick play mode so as to superimpose the decoded image data 106 about the blocks on one another, to make the image storage means 3 store the superimposed decoded image data, and to make the image storage means output the decoded image data 106 about the blocks stored in the image storage means at a playback speed which is specified thereby.

Next, the operation of the coded-data decoding/playback apparatus according to this embodiment will be explained. The compressed image data 101 according to a predetermined compression coding method are stored in the input data buffer 11. In general, data coded in a plurality of coding modes are included in the compressed image data 101. The plurality of coding modes can include an intra coding mode in which coding processing can be completed using only data included in the target image to be coded, and an inter coding (non-intra coding) mode having a uni-directional prediction and a bidirectional prediction in a case of, for example, an MPEG-based coding method which uses predictions from other images different from the target image with respect to time. The inter coding mode includes various variations according to the types of predictions. It is also possible to restrictly apply a coding mode on a frame-by-frame basis. Compressed image data 101 about a frame which is all coded in the intra coding mode is called an intra frame (or an intra picture).

The compressed image data 101 stored in the data buffer 11 are serially furnished to the variable length decoding unit 12. The variable length decoding unit 12 variable-length-decodes the compressed image data 101, and outputs coded coefficient data 102 and a quantization parameter 103 to the inverse quantization unit 13, outputs coding mode information 104 to the switcher 17, and outputs coding parameters 105 containing the coding mode information 104 and a motion vector to the motion compensation unit 16. The inverse quantization unit 13 carries out inverse quantization of the coded coefficient data 102 on the basis of the quantization parameter 103, and the inverse orthogonal transformation unit 14 carries out reverse orthogonal transformation of the output of the inverse quantization unit 13, and outputs decoded image data 106. The decoded image data 106 from the inverse orthogonal transformation unit 14 are outputted to the adder 15 and switcher 17.

As input terminals of the switcher 17, an input terminal a connected to the output of the inverse orthogonal transformation unit 14, an input terminal b which is open-circuited, and an input terminal c connected to the output of the adder 15 are disposed.

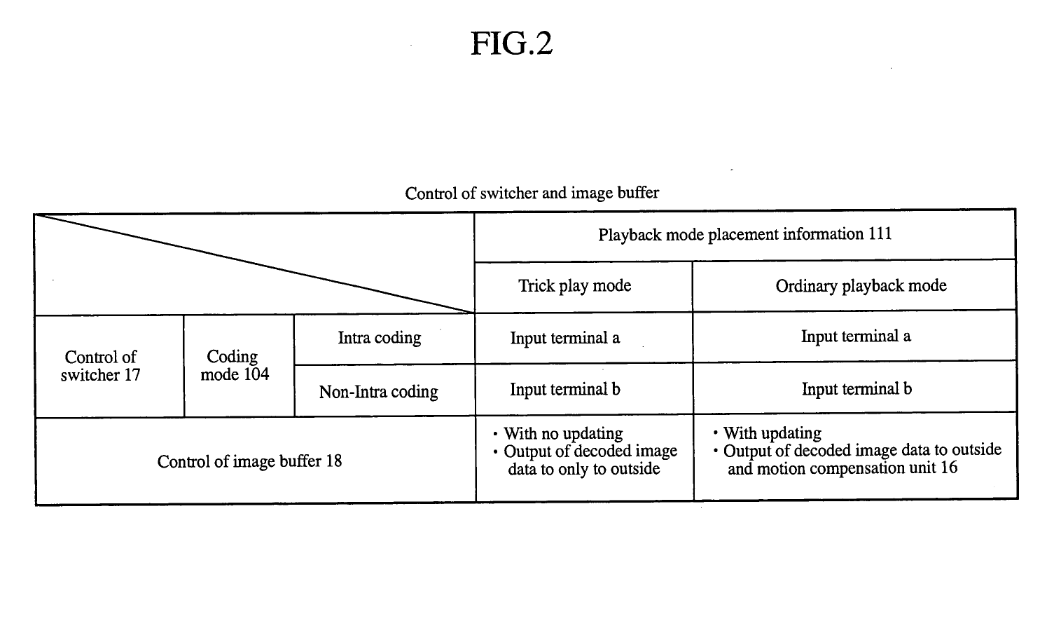

FIG. 2 is a diagram for explaining control of the switcher 17 and image buffer 18. The switcher 17 is controlled by both the coding mode information 104 from the variable length decoding unit 12 and playback mode placement information 111 from outside the coded-data decoding/playback apparatus. That is, when the coding mode information 104 indicates the intra coding in which the target image can be decoded independently, the switcher 17 selects the input terminal a even if the playback mode placement information 111 indicates the placement of the image decoding means in either of the trick play mode and ordinary playback mode, whereas when the coding mode information 104 indicates the non-intra coding in which the target image cannot be decoded independently, selects the input terminal b if the playback mode placement information 111 indicates the placement of the image decoding means in the trick play mode, or selects the input terminal c if the playback mode specification 111 indicates the placement of the image decoding means in the ordinary playback mode. When the playback mode placement information 111 indicates the placement of the image decoding means in the trick play mode, the image buffer 18 is so controlled as not to update the decoded image data 106 stored therein on a frame-by-frame basis and is also so controlled as to output the decoded image data 106 stored therein to outside the coded-data decoding/playback apparatus, but as not to output the decoded image data 106 to the motion compensation unit 16. In contrast, when the playback mode placement information 111 indicates the ordinary playback mode, the image buffer 18 is so controlled as to update the decoded image data 106 stored therein on a frame-by-frame basis and is also so controlled as to output the decoded image data 106 stored therein to both outside the coded-data decoding/playback apparatus and the motion compensation unit 16.

First, the operation of the coded-data decoding/playback apparatus in the case where the playback mode placement information 111 indicates the placement of the image decoding means in the ordinary playback mode will be explained. When the coding mode information 104 indicates the intra coding, the switcher 17 selects the input terminal a so that the decoded image data 106 from the inverse orthogonal transformation unit 14 is stored in the image buffer 18 just as they are, and the decoded image data 106 stored are outputted at a predetermined speed which is specified by the playback speed specification information 112 and are updated on a frame-by-frame basis.

On the other hand, when the coding mode information 104 indicates the non-intra coding, the switcher 17 selects the input terminal c so that decoded image data 106 which is the sum of the decoded image data 106 from the adder 15, i.e., the decoded data image 106 from the inverse orthogonal transformation unit 14, and prediction image data generated on the basis of both the coding parameters 105 from the motion compensation unit 16 and the decoded image data 106 stored in the image buffer 18 are stored in the image buffer 18, and the decoded image data 106 stored in the image buffer 18 are outputted at a predetermined speed which is specified by the playback speed specification information 112 and are updated on a frame-by-frame basis.

Next, the operation of the coded-data decoding/playback apparatus in the case where the playback mode placement information 111 indicates the placement of the image decoding means in the trick play mode will be explained. When the coding mode information 104 indicates the intra coding, the switcher 17 selects the input terminal a so that the decoded image data 106 from the inverse orthogonal transformation unit 14 are stored in the image buffer 18 just as they are, and the decoded image data 106 stored in the image buffer 18 are not updated on a frame-by-frame basis, but are outputted at a high speed specified by the playback speed specification information 112.

On the other hand, when the coding mode information 104 indicates the non-intra coding, the switcher 17 selects the input terminal b so that the decoded image data 106 from the inverse orthogonal transformation unit 14 are not stored in the image buffer 18 and therefore are not outputted from this coded-data decoding/playback apparatus.

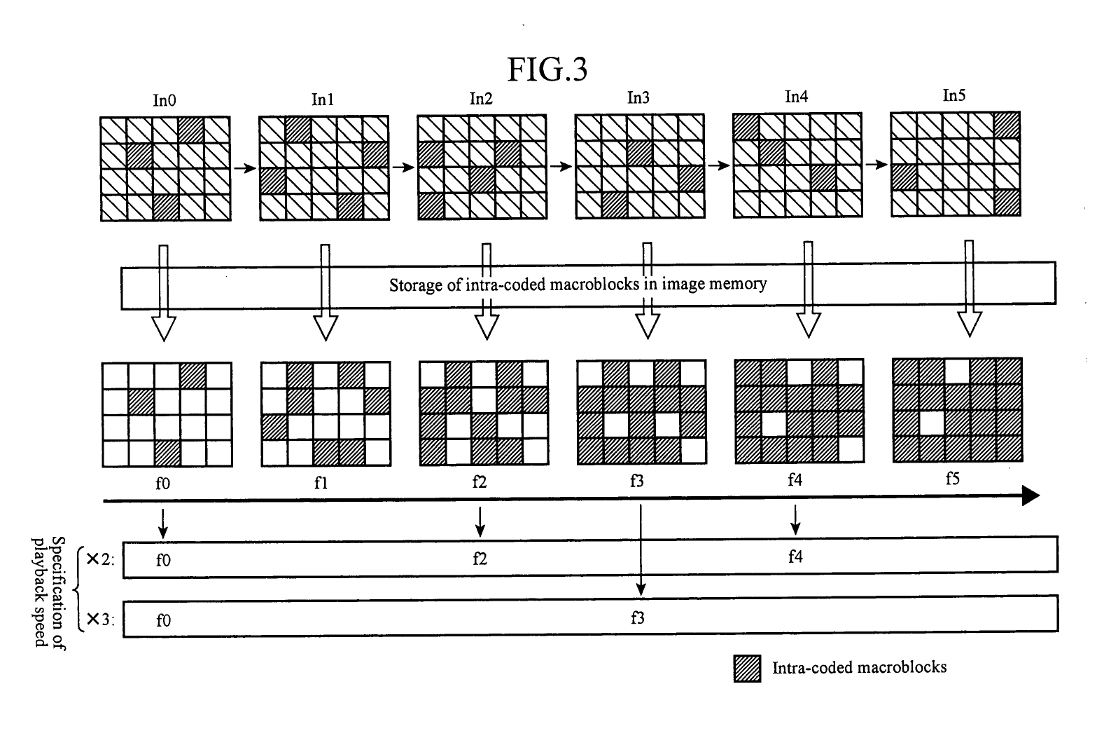

FIG. 3 is a diagram explaining the operation of the coded-data decoding/playback apparatus in the trick play mode when the inputted compressed image data 101 include data coded in a plurality of coding modes. In FIG. 3, the time advances from left to right, the upper portion of FIG. 3 shows distributions of macroblocks (hatched portion) of intra-coded data included in the inputted compressed image data 101, the middle portion of FIG. 3 shows states of the decoded image data 106 about the macroblocks of the intra-coded data stored in the image buffer 18, and the lower portion of FIG. 3 shows states of the decoded image data 106 outputted to outside the coded-data decoding/playback apparatus under the control of the playback speed specification information 112.

Three macroblocks of intra-coded data are included in a frame In0. In this case, since the coding mode information 104 indicates the intra coding and the playback mode placement information 111 indicates the placement of the image decoding means in the trick play mode, the switcher 17 selects the input terminal a so that decoded image data 106 which are obtained by decoding the macroblocks of intra-coded data are written into the image buffer 18. Other macroblocks of non-intra-coded data which have been coded with coding other than the intra coding are not furnished to the switcher 17, and decoded image data 106 which are obtained by decoding the macroblocks of non-intra-coded data are not written into the image buffer 18. Since the update of the decoded image data 106 currently written into the image buffer 18 is not performed, decoded image data 106 which are obtained by decoding macroblocks of intra-coded data of subsequent frames In1, In2, . . . , In5 furnished to the coded-data decoding/playback apparatus one after another are superimposed on one another and are stored in the image buffer 18. Although there is no regularity in the arrangement of macroblocks of intra-coded data, in general, an intra-coded macroblock appears every second in many cases. According to the MPEG specifications, it is specified that a macroblock of intra-coded data certainly appears every 132 times. After a certain amount of time elapses, as shown in FIG. 3, the entire screen will be gradually filled with the outputs of macroblocks of intra-coded data.

Then, the timing of the output of the decoded image data 106 stored in the image buffer 18 is determined by the playback speed specification information 112. Although the decoded image data 106 stored in the image buffer 18 changes from a storage state f0, via storage states f1, f2, and . . . , to a final storage state, as shown in FIG. 3, there is no necessity to output these decoded image data 106 sequentially. There is also no necessity to output the decoded image data 106 sequentially from the viewpoint of the fast forward playback. Therefore, the specification of a multiple-times playback speed from outside the coded-data decoding/playback apparatus is done using the playback speed specification information 112, for example, and the output timing is determined from the multiple-times playback speed. As shown in FIG. 3, when a double playback speed is specified, the coded-data decoding/playback apparatus outputs the decoded image data 106 at the output times corresponding to the storage states f0, f2, and f4, and, when a triple playback speed is specified, the coded-data decoding/playback apparatus outputs the decoded image data 106 at the output times corresponding to the storage states f0, f3, f6, and . . . .

In this embodiment 1, a macroblock which is the smallest unit for coding is defined as a block containing intra-coded data. As an alternative, either a slice which is a collection of a plurality of intra macroblocks to which a header is added and which is the smallest unit of resynchronization, or a picture which is a frame all of which consists of intra macroblocks, and which is a unit of image is defined as a block containing intra-coded data. In either case, fast forward playback can be performed similarly.

As mentioned above, the coded-data decoding/playback apparatus according to this embodiment 1 uses inputted original compressed image data 101 just as they are in order to perform trick mode playback processing. Therefore, the present embodiment offers an advantage of being able to avoid the necessity for additionally holding compressed image data into which the inputted original compressed image data are converted and to implement the trick mode playback function with a simple structure by performing trick mode playback processing simultaneously during the process of decoding the inputted compressed image data 101.

### Embodiment 2

A coded-data decoding/playback apparatus in accordance with embodiment 2 of the present invention has the same structure as shown in the block diagram of FIG. 1 of embodiment 1, basically. In this embodiment 2, compressed image data 101 are stored in a storage medium, such as an HDD or memory, which can be accessed at random, for example. Assume that in the trick play mode the coded-data decoding/playback apparatus of this embodiment reads the compressed image data 101 stored in the storage medium in reverse chronological order, i.e., in a direction opposite to the time direction of the coded stream transmitted thereto.

In this embodiment 2, the input data buffer 11 of FIG. 1 constitutes an image input means 1 for inputting the compressed image data 101 which can be accessed at random in a direction opposite to the time direction of the coded stream transmitted thereto.

Next, the operation of the coded-data decoding/playback apparatus in accordance with this embodiment of the present invention will be explained.

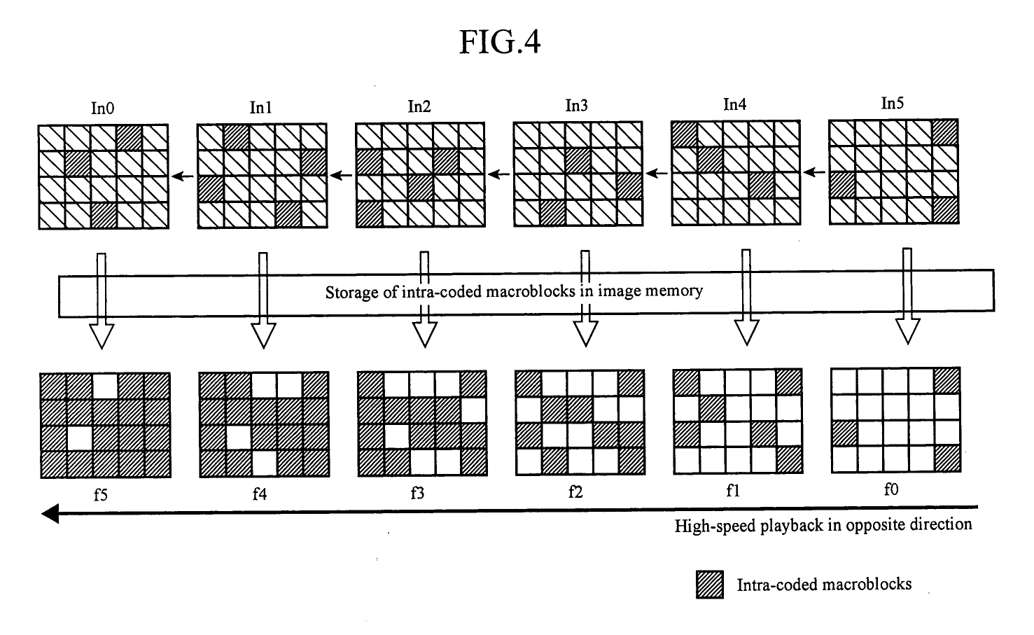

FIG. 4 is a diagram for explaining the operation in the trick play mode of the coded-data decoding/playback apparatus when the inputted compressed image data 101 include data coded in a plurality of coding modes. The compressed image data 101 are inputted to the coded-data decoding/playback apparatus in order of frames In5, In4, . . . , and In0 which are running from a right side to a left side of FIG. 4, and decoded image data which are obtained by decoding intra-coded macroblocks (hatched portions) included in the compressed image data 101 are written into the image buffer 18 one after another.

When the playback mode placement information 111 is so set as to indicate the placement of the image decoding means in the trick play mode, and the playback speed specification information 112 is so set as to indicate specification of fast forward playback such as double-speed or triple-speed playback, the coded-data decoding/playback apparatus carries out fast forward playback of the decoded image data in order of storage states f0, f1, and . . . , i.e., in reverse chronological order, as shown in FIG. 4. Thus, the coded-data decoding/playback apparatus can carry out reverse playback of the decoded image data in the same way that a tape is rewound in a VTR.

As mentioned above, the coded-data decoding/playback apparatus according to this embodiment 2 uses inputted original compressed image data 101 just as they are in order to perform trick mode playback processing. Therefore, the present embodiment offers an advantage of being able to avoid the necessity for additionally holding compressed image data into which the inputted original compressed image data are converted and to implement the trick mode playback function with a simple structure by inputting the compressed image data 101 which can be accessed at random in a direction opposite to the time direction of the coded stream transmitted thereto.

### Embodiment 3

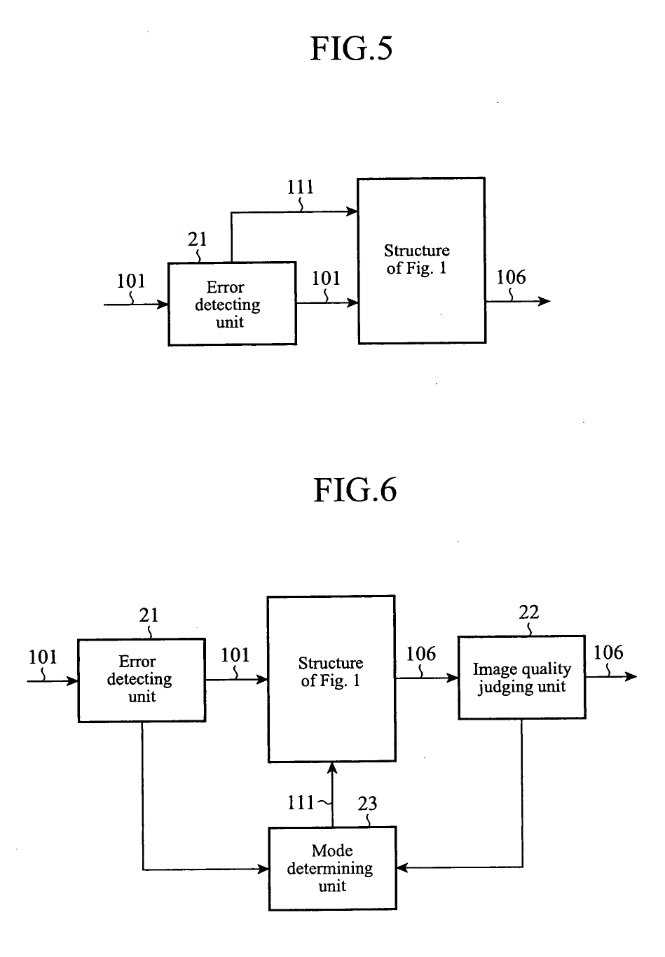

FIG. 5 is a block diagram showing the structure of a coded-data decoding/playback apparatus in accordance with embodiment 3 of the present invention. This coded-data decoding/playback apparatus has an error detecting unit 21 in addition to the structure of that according to embodiment 1 shown FIG. 1.

Next, the operation of the coded-data decoding/playback apparatus in accordance with this embodiment of the present invention will be explained.

When an error is mixed into compressed image data 101 including data coded using prediction coding, such as MPEG-based coding, various errors can occur in the compressed image data 101 when the compressed image data 101 are decoded. Particularly, if an error is mixed into a motion vector which is used when prediction image data is generated, since it is impossible to carry out prediction from an area which is needed originally, an error called drift occurs. As a result, when the decoding operation is continued with such an error occurred, a moving image in which all objects become blurred as if they were melted is outputted and therefore its image quality degrades substantially from the viewpoint of human being's vision. This embodiment 3 aims at preventing the quality degradation from the viewpoint of human being's vision.

The error detecting unit 21 detects occurrence of an error in the compressed image data 101 inputted to the coded-data decoding/playback apparatus, and when detecting that errors have occurred in the inputted compressed image data at a high frequency, outputs playback mode placement information 111 indicating the placement of an image decoding means in a trick play mode to a switcher 17 and an image buffer 18 of FIG. 1. The switcher 17 stores decoded image data 106 about macroblocks of intra-coded data in the image buffer 18, like that of embodiment 1, and the image buffer 18 outputs the decoded image data 106 of macroblocks of intra-coded data stored therein according to the playback mode placement information 111 indicating the placement of the image decoding means in the trick play mode, and playback speed specification information 112, like that of embodiment 1. Thus, the coded-data decoding/playback apparatus can output the decoded image data 106 having little degradation visually.

As mentioned above, the coded-data decoding/playback apparatus according to this embodiment 3 uses inputted original compressed image data 101 just as they are in order to perform trick mode playback processing. Therefore, the present embodiment offers an advantage of being able to avoid the necessity for additionally holding compressed image data into which the inputted original compressed image data are converted and to implement the trick mode playback function with a simple structure by, when detecting that errors have occurred in the inputted compressed image data at a high frequency, performing the trick mode playback processing simultaneously during the process of decoding the inputted compressed image data 101, thereby outputting decoded image data 106 having little degradation visually.

### Embodiment 4

FIG. 6 is a block diagram showing the structure of a coded-data decoding/playback apparatus in accordance with embodiment 4 of the present invention. This coded-data decoding/playback apparatus has an error detecting unit 21, an image quality judging unit 22, and a mode determining unit 23 in addition to the structure of that of embodiment 1 shown in FIG. 1.

Next, the operation of this coded-data decoding/playback apparatus in accordance with embodiment of the present invention will be explained.

The error detecting unit 21 detects occurrence of an error in compressed image data 101 inputted to the coded-data decoding/playback apparatus, and notifies information about the detection result to the mode determining unit 23. The image quality judging unit 22 examines frequency components included in the decoded image data 106 outputted from an image buffer 18 so as to judge the quality of the decoded image data 106, and notifies the judged quality to the mode determining unit 23.

Even though the notification from the error detecting unit 21 indicates that an error has occurred in the compressed image data 101, the mode determining unit 23 outputs playback mode placement information 111 indicating the placement of an image decoding means in an ordinary playback mode to a switcher 17 and an image buffer 18 if determining that there is no problem in the quality of the decoded image data 106 notified thereto by the image quality judging unit 22. The switcher 17 and image buffer 18 then perform a playback operation in the ordinary playback mode in the same way that those of embodiment 1 do.

On the other hand, when the notification from the error detecting unit 21 indicates that an error has occurred in the compressed image data 101, and the mode determining unit 23 then determines there is a problem in the quality of the decoded image data 106 notified thereto by the image quality judging unit 22, the mode determining unit 23 outputs the playback mode specification 111 indicating the placement of the image decoding means in a trick play mode to the switcher 17 and image buffer 18. The switcher 17 then stores the decoded image data 106 about macroblocks of intra-coded data in the image buffer 18, like that of embodiment 1, and the image buffer 18 outputs the decoded image data 106 of macroblocks of intra-coded data stored therein according to the playback mode placement information 111 indicating the placement of the image decoding means in the trick play mode, and playback speed specification information 112, like that of embodiment 1. Thus, the coded-data decoding/playback apparatus can output the decoded image data 106 having little degradation visually.

As mentioned above, the coded-data decoding/playback apparatus according to this embodiment 4 uses inputted original compressed image data 101 just as they are in order to perform trick mode playback processing. Therefore, the present embodiment offers an advantage of being able to avoid the necessity for additionally holding compressed image data into which the inputted original compressed image data are converted and to implement the trick mode playback function with a simple structure by simultaneously performing the trick mode playback processing according to the quality of the decoded image data 106 during the process of decoding the inputted compressed image data 101, thereby outputting decoded image data 106 having little degradation visually.

### INDUSTRIAL APPLICABILITY

As mentioned above, the coded-data decoding/playback apparatus in accordance with the present invention can avoid the necessity for additionally holding compressed image data into which inputted original compressed image data are converted, and is suitable for implementation of a trick mode playback function with a simple structure.

1. A coded-data decoding/playback apparatus comprising: an image input means for inputting compressed image data;
an image decoding means for decoding blocks containing intra-coded data which can be independently decoded and which is included in the compressed image data inputted by said image input means in response to placement of said image decoding means in a trick play mode in which image data is played back at a high speed;
an image storage means for storing decoded image data about said blocks decoded by said image decoding means; and
an image decoding/playback control means for placing said image decoding means and said image storage means in the trick play mode so as to superimpose the decoded image data about said blocks on one another, to make said image storage means store the superimposed decoded image data, and to make said image storage means output the decoded image data about said blocks stored in said image storage means at a playback speed which is specified thereby.

2. The coded-data decoding/playback apparatus according to claim 1, characterized in that the blocks containing intra-coded data which can be decoded independently and which is selected and decoded by said image decoding means are macroblocks each of which is a smallest unit of coding, slices each of which is a smallest unit of resynchronization, or pictures each of which is a unit of image.

3. The coded-data decoding/playback apparatus according to claim 1, characterized in that said image input means inputs compressed image data which can be accessed at random in a direction opposite to a time direction of a coded stream transmitted.

4. The coded-data decoding/playback apparatus according to claim 1, characterized in that said apparatus includes an error detecting unit for detecting occurrence of an error in the compressed image data inputted by said image input means, and for, when error occur in the compressed image data at a high frequency, making said image decoding/playback control means select specification of the trick play mode.

5. The coded-data decoding/playback apparatus according to claim 1, characterized in that said apparatus includes an error detecting unit for detecting occurrence of an error in the compressed image data inputted by said image input means, an image quality judging unit for judging quality of the decoded image data outputted from said image storage means, and a mode determining unit for making said image decoding/playback control means specify the trick play mode when said error detecting unit detects occurrence of an error in the compressed image data, and said image quality judging unit judges that a problem arises in quality of the decoded image data outputted from said image storage means.
